(19) United States
(12) Patent Application Publication
(10) Pub. No.: US 2006/0154705 A1
(43) Pub. Date: Jul. 13, 2006

(54) Slide-type portable terminal provided with game function

(75) Inventor: Young S. Kim, Palo Alto, CA (US)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/264,969

(22) Filed: Nov. 2, 2005

(30) Foreign Application Priority Data
Jan. 11, 2005 (KR) 10-2005-0002516

(51) Int. Cl. H04M 1/00

(52) U.S. Cl. 455/575.4

(57) ABSTRACT

A slide-type portable terminal which is convenient to use in a telephone mode, a game mode, and a camera mode is disclosed. The portable terminal includes a body housing; a circumferential portion surrounding the body housing; an opening provided between the body housing and the circumferential portion; an auxiliary rotary housing received in the opening and connected so as to be rotated about a hinge axis of the body housing; and a slide housing slidable along a lengthwise direction of the body housing, the slide housing opening/closing a portion of the upper surface of the body housing and opening/closing a surface of the auxiliary rotary housing.

### PRIORITY

This application claims priority to an application entitled “SLIDE TYPE PORTABLE TERMINAL WITH GAME FUNCTION” filed with the Korean Intellectual Property Office on Jan. 11, 2005 and assigned Serial No. 2005-2516, the contents of which are incorporated herein by reference.

### BACKGROUND OF THE INVENTION

1. Field of the Invention

The present invention relates to a digital-type portable terminal such as a cellular phone, a PDA (Personal Digital Assistant), an HHP (Hand Held Phone), a camera phone, a game phone, an Internet phone, and a message phone, and more particularly to a slide type portable terminal provided with a game function which is convenient to use in a telephone mode, a game mode, and a camera mode.

2. Description of the Related Art

In general, the term “portable communication device” refers to an electronic device that a user can carry to perform wireless communication with a desired partner. To facilitate portability, designs of such portable communication devices tend not only to be compact, slim, and light, but are also moving toward providing multimedia availability, having a wider variety of functions. In particular, future portable communication devices are expected to incorporate greater multi-functionality and be capable of multi-purpose utilization, as well as being more compact, light, and capable of being modified to be suitable for various multimedia or Internet environments. Additionally, portable communication devices are now commonly used by people of all ages and all walks of life throughout the world, and are recognized by some people as a nearly indispensable commodity which should be carried all the time.

Portable communication devices may be classified into various categories according to their appearance, such as a bar-type portable communication device, a flip-type portable communication device, and a folder-type portable communication device. A bar-type portable communication device refers to a device having a single housing of a bar-shape. A flip-type portable communication device refers to a device in which a flip is rotatably mounted to a housing by a hinge unit. A folder-type communication device refers to manner in which a folder is rotatably connected to a single bar-type housing by a hinge unit.

Portable communication devices may also be classified into a necklace type portable communication device and a wrist or bracelet type portable communication device according to the wearing position or the way in which users put on the portable communication devices. The necklace type portable communication device refers to a portable manner in which a terminal is worn around a neck of a user using a string. Further, the bracelet type portable communication device refers to a portable manner in which a terminal is worn around a wrist of a user.

In addition, portable communication devices may be classified into a rotation-type portable communication device and a slide-type communication device according to the manner of opening and closing the portable communication device. The rotation-type portable communication device refers to a manner in which two housings are rotatably connected, opposed to each other. The slide-type communication device refers to a manner in which two housings are slid with respect to each other in the lengthwise direction of the device. These variously classified portable communication devices can be easily understood by those skilled in the art.

Meanwhile, conventional portable communication devices now tend to transmit data at a high speed in addition to performing the basic voice communication function. In other words, according to the increase in consumer demand, portable communication devices now tend to provide a service using a wireless communication technology capable of transmitting data at high speed.

Recent portable communication devices also tend to be equipped with a camera lens to obtain video signals for transmission. In other words, current portable communication devices have an external or embedded camera lens module which enables users to perform video communication with desired partners or to photograph desired subjects.

However, according to the conventional portable communication devices, since the camera lenses are fixably provided, the photographing operations are inconvenient and there are problems in manipulating the keys with both hands in a game mode. Actually, in game mode, only when a wide landscape mode, the capability of key manipulation using both hands, and stereo sound are provided, can a user be absorbed in the game in optimum conditions and the user's interest in the game increases.

Further, since the conventional portable communication devices do not have separate protecting means, the bodies, camera lenses, or antennas of the devices may be broken when the devices are dropped. Therefore, there has been a request for a portable device which is protected when dropped, can be conveniently used in a camera mode, has keys which can be conveniently manipulated in a game mode, and can provide a wide landscape mode screen.

### SUMMARY OF THE INVENTION

Accordingly, the present invention has been made to solve the above-mentioned problems occurring in the prior art, and an object of the present invention is to provide a slide-type portable terminal which is convenient in a telephone mode, a game mode, and a camera mode.

Another object of the present invention is to provide a slide-type portable terminal which provides a wide landscape mode screen and is convenient in manipulating keys with both hands.

Another object of the present invention is to provide a slide-type portable terminal which can minimize damage to the terminal when dropped by receiving a body housing and an auxiliary rotary housing in a circumferential protective portion.

Another object of the present invention is to provide a slide-type portable terminal which uses a camera lens provided in an auxiliary rotary housing in a camera mode and protects the camera lens from the exterior environment when it is not used.

In order to accomplish these objects, there is provided a portable terminal including a body housing; a circumferential portion surrounding the body housing; an opening means provided between the body housing and the circumferential portion; an auxiliary rotary housing received in the opening means and connected so as to be rotated about a hinge axis of the body housing; and a slide housing slidable along a lengthwise direction of the body housing, the slide housing opening/closing a portion of an upper surface of the body housing and opening/closing one surface of the auxiliary rotary housing.

### BRIEF DESCRIPTION OF THE DRAWINGS

The above and other objects, features, and advantages of the present invention will be more apparent from the following detailed description taken in conjunction with the accompanying drawings, in which:

FIG. 1 is a front view of a portable terminal according to a preferred embodiment of the present invention;

FIG. 2 is a front view of the portable terminal of FIG. 1 with a slide housing thereof completely slid;

FIG. 3 is a front view of the portable terminal of FIG. 1 with an auxiliary rotary housing rotated by about ninety degrees;

FIG. 4 is a bottom view of the portable terminal of FIG. 1; and

FIG. 5 is a view of the portable terminal of FIG. 1 with the slide housing moved by a predetermined distance for use in a game mode.

### DETAILED DESCRIPTION OF THE PREFERRED EMBODIMENT

Hereinafter, a preferred embodiment of the present invention will be described with reference to the accompanying drawings. In the following description of the present invention, a detailed description of known functions and configurations incorporated herein is omitted to avoid making the subject matter of the present invention unclear.

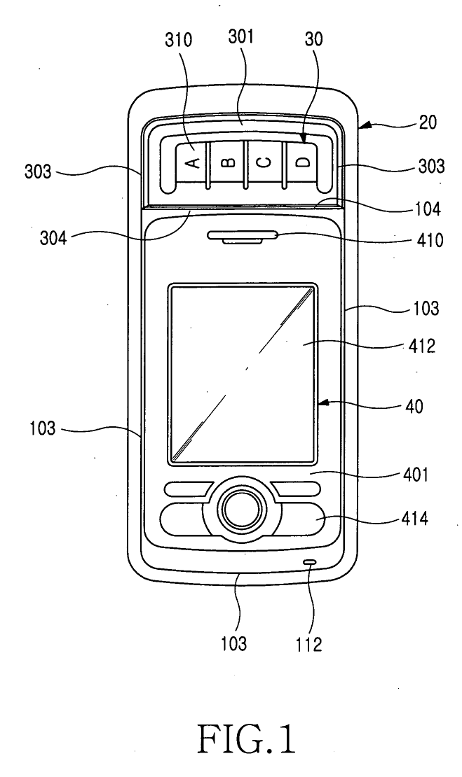

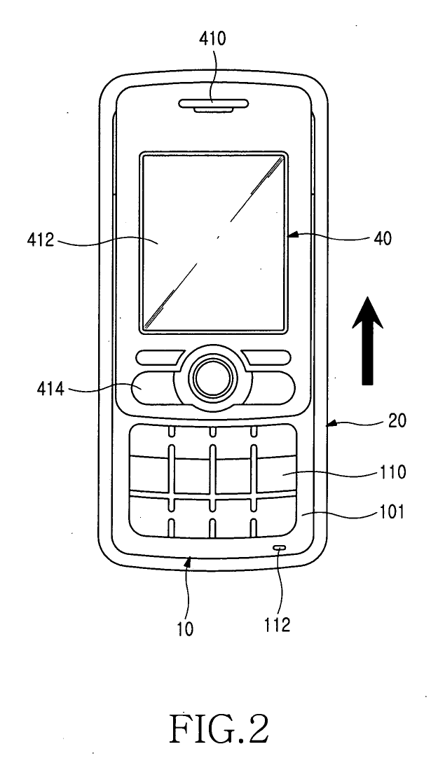

As shown in FIGS. 1 and 2, a portable terminal according to the present invention includes an auxiliary rotary housing 30, a body housing 10 surrounded by a circumferential portion 20, and a slide housing 40 which is opened and closed with respect to the body housing 10. The portable terminal is convenient in a telephone mode, a game mode (landscape mode), and a camera mode.

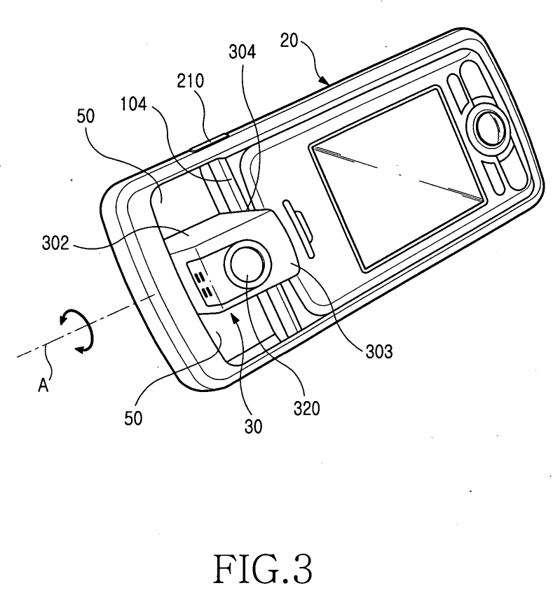

The portable terminal includes body housing 10, circumferential portion 20 surrounding and receiving a side end 103 of the body housing 10, an opening 50 (refer to FIG. 3) provided between the body housing 10 and the circumferential portion 20, an auxiliary rotary housing 30 rotatable about a hinge axis A of the body housing 10, received in the opening 50, a slide housing 40 slidable along the lengthwise direction of the body housing 10 and opening/closing one selected surface of the auxiliary rotary housing 30. The rotary housing 30 is rotated about the hinge axis A, with one side surface 104 of an upper end of the body housing 10 continuously facing one side surface of a lower end of the auxiliary rotary housing. The hinge axis A turns extends in the lengthwise direction of the body housing 10, and more particularly extends in the lengthwise direction or the sliding direction of the slide housing 40. The hinge axis A penetrates the center of the side surface 104 of the upper end of the body housing 10. Further, as described below, the slide housing 40 slides in two steps by a slide module (not shown). FIG. 2 shows the state in which the slide housing has been completely slid.

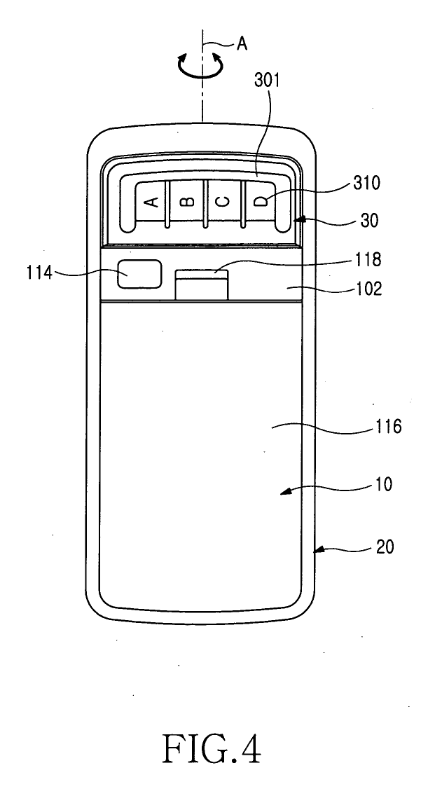

As shown in FIGS. 1 and 4, the body housing 10 preferably has a rectangular shape. A partial area of the upper surface 101 of the body housing 10 is opened or closed according to the sliding state of the slide housing 40, the rest of the upper surface 101 thereof is always concealed, and the bottom surface area 102 (refer to FIG. 4) is always exposed. In detail, first keys 110 including a plurality of keys and a microphone unit 112 are provided on the upper surface 101 of the body housing 10, and an illumination unit 114, a battery pack 116, and a locking knob 118 for detachably attaching the battery pack 116 are provided on the bottom surface 102 thereof. The first keys 110 are adjacent to the microphone unit 112, and the illumination unit 114 is adjacent to the battery pack 116. The first keys 110 are opened or closed according to the sliding state of the slide housing 40, and the microphone unit is always exposed regardless of the opening/closing state of the slide housing 40.

The upper surface 101 of the body housing 10 is moved linearly, continuously facing the bottom surface of the slide housing 40. Further, the body housing 10 is disposed in the circumferential portion 20 in side by side relation to the auxiliary rotary housing 30.

Further, the slide housing 40 preferably is not received in the circumferential portion 20. A speaker unit 410, a display unit 412 adjacent to the speaker unit 410, and a plurality of third keys 414 adjacent to the display unit 412 and always exposed are provided on the upper surface 401 of the slide housing 40. The bottom surface of the slide housing 40 is slid with respect to one of the upper surface 301 and the lower surface 302 of the auxiliary rotary housing 30. Unless the auxiliary housing 30 is rotated and is completely received in the circumferential portion 20, the slide movement of the slide housing 40 is restricted. In other words, only when the auxiliary rotary housing 30 is completely received in the circumferential portion 20, can the slide housing 40 slide.

The auxiliary rotary housing 30 has an upper surface 301 and a lower surface 302, and curvature radii are provided on both side surfaces 303 thereof to allow a smooth rotating operation. On the upper surface 301 of the auxiliary rotary housing 30 are formed a plurality of second keys 310 which can be exposed or covered according the sliding state of the slide housing 40 and be disposed on a same plane as the upper surface 101 or the bottom surface 102 of the body housing 10. Printed marking portions of the second keys 310 are marked transversely. Namely, it is convenient to conform the marked contents of the second keys 310 in a game mode as shown in FIG. 1.

The auxiliary rotary housing 30 is disposed in the circumferential portion 20 in side by side relation with the body housing 10, and is completely or partially received according the rotating state thereof. A camera lens 320 is provided on one side surface of the auxiliary rotary housing 30, which is concealed in the circumferential portion 20 or exposed according to the rotating state thereof. In a camera mode, the auxiliary rotary housing 30 is necessarily rotated to open the camera lens 320.

The circumferential portion 20 is preferably formed of a metal or a resilient plastic, and protects the body housing 10 and the auxiliary rotary housing 30 when the terminal is dropped. The circumferential portion 20 surrounds the side surfaces of the body housing 10 and the auxiliary rotary housing 30.

As shown in FIG. 3, side keys 210 are provided on the circumferential portion 20 to allow convenient manipulation of the keys.

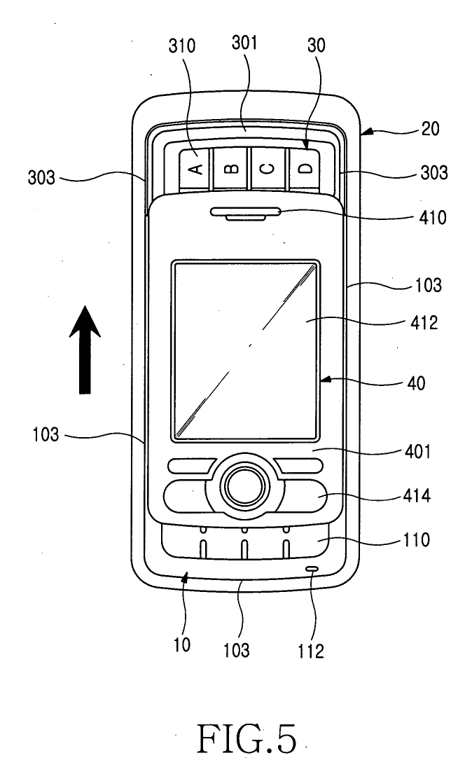

As shown in FIG. 5, the slide housing 40 is opened in two steps. More particularly, if a force is applied to the slide housing 40 in the state shown in FIG. 1, the terminal moves to the state of FIG. 5. Further, if a force is additionally applied to the slide housing 40, the terminal moves to the state of FIG. 2. At a first position shown in FIG. 5, some of the first keys 110 and all of the second keys 310 of the auxiliary rotary housing 30 are exposed, the rest of the first keys 110 are covered, and the display device 412 is disposed between the opened first keys 110 and second keys 310. At a second position shown in FIG. 2, all of the first keys 110 are exposed by the complete sliding movement of the slide housing 40. In the game mode of FIG. 5, the exposed keys 110 and 310 may be manipulated by the user using both hands, thereby enabling the user to accurately and promptly manipulate the keys during a game.

FIG. 1 represents a telephone or waiting mode, FIG. 2 shows the portable terminal in the telephone mode, FIG. 3 shows the portable terminal in the camera mode, and FIG. 5 shows the portable terminal in the game mode.

As mentioned above, since the portable terminal according to the present invention provides the body housing, the rotary housing, the slide housing, and the circumferential portion so as to have an optimum structure, it can be conveniently used in the game mode, the camera mode, or the telephone mode. While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A portable terminal comprising:
a body housing;
a circumferential portion surrounding the body housing;
an opening provided between the body housing and the circumferential portion;
an auxiliary rotary housing received in the opening and rotatable about a hinge axis of the body housing; and
a slide housing slidable along a lengthwise direction of the body housing, the slide housing opening/closing a portion of an upper surface of the body housing and opening/closing a surface of the auxiliary rotary housing.

2. A portable terminal according to claim 1, wherein the auxiliary rotary housing is disposed in side by side relation with the body housing and is received within the circumferential portion.

3. A portable terminal according to claim 1, wherein the auxiliary rotary housing is rotatable about the hinge axis, with one side surface of an upper end of the body housing continuously facing one side surface of a lower end of the auxiliary rotary housing, and wherein when the slide housing slides, the upper surface of the body housing continuously faces a bottom surface of the slide housing, and the bottom surface of the slide housing slides with respect to one of an upper surface and a lower surface of the auxiliary rotary housing.

4. A portable terminal according to claim 1, wherein a camera lens is provided on a side surface of the auxiliary rotary housing and is concealed by the circumferential portion or exposed according to rotation of the auxiliary rotary housing.

5. A portable terminal according to claim 1, wherein curvature radii are provided on both side surfaces of the auxiliary rotary housing.

6. A portable terminal according to claim 1, wherein:
the body housing includes a plurality of first keys disposed on the upper surface of the body housing and an illumination unit and a battery pack disposed on a bottom surface of the body housing, the first keys being exposed and covered according to sliding of the slide housing, the battery pack being located adjacent to the illumination unit.

7. A portable terminal according to claim 6, wherein:
the auxiliary rotary housing includes a plurality of second keys disposed on an upper surface of the auxiliary rotary housing, the second keys being exposed and covered according to sliding of the slide housing and disposed in a same plane as the upper surface or the bottom surface of the body housing.

8. A portable terminal according to claim 7, wherein:
the slide housing includes a speaker unit, a display unit adjacent to the speaker unit, and a plurality of third keys, which are disposed on an upper surface of the slide housing, the third keys being located adjacent to the display unit and always exposed.

9. A portable terminal according to claim 6, wherein the slide housing slides on the body housing in two steps, exposes some of the first keys and covers the rest of the first keys at a first position, and exposes all of the first keys at a second position.

10. A portable terminal according to claim 6, wherein marking portions of the second keys are transversely printed for use in a game mode.

11. A portable terminal according to claim 1, wherein the slide housing is not received in the circumferential portion.

12. A portable terminal according to claim 1, wherein the slide housing slides only when the auxiliary rotary housing is not rotated.

13. A portable terminal according to claim 1, wherein the circumferential portion is formed of one of a metal and a plastic.

14. A portable terminal according to claim 1, wherein the hinge axis extends through the center of a side surface of an upper end of the body housing in the lengthwise direction of the body housing.

15. A portable terminal according to claim 6, wherein a microphone unit is always exposed regardless of the opening/closing state of the slide housing.

16. A portable terminal according to claim 1, wherein the circumferential portion includes side keys.

17. A portable terminal comprising:
a body housing having first keys;
a circumferential portion surrounding the body housing;
an opening provided between the body housing and the circumferential portion;
an auxiliary rotary housing received in the opening and rotatable about a hinge axis of the body housing, the auxiliary rotary housing having second keys; and
a slide housing slidable with respect to the body housing in multi-steps, so that some of the first keys are exposed, the rest of the first keys are covered, and the second keys are exposed at a first position, and all of the first keys are exposed and all of the second keys are covered at a second position.
